(19) United States
(12) Patent Application Publication
(10) Pub. No.: US 2002/0099887 A1
(43) Pub. Date: Jul. 25, 2002

(54) Keyboard combined with data storage medium

(76) Inventor: Ho-Lung Lu, Taipei Hsien (TW)

Correspondence Address: Rosenberg, Klein & Lee, Suite 101, 3458 Ellicott Center Drive, Ellicott City, MD, 21043, US

(21) Appl. No.: 09/766,604

(22) Filed: Jan. 23, 2001

(51) Int. Cl. G06F 13/12

(52) U.S. Cl. 710/74; 235/74

(57) ABSTRACT

A keyboard combined with a data storage medium is disclosed. The keyboard combined with a data storage medium comprises a housing, a keyboard and a storage medium. The housing consists of a slot and a communication means for transferring data to and from a client system, such as a portable, a handheld or a desktop computer. The keyboard is installed on the housing for inputting data, or giving commands to operate the destination client system. A storage medium is inserted into the slot for expanding the storage space of the handheld client system through the communication means.

### FIELD OF THE INVENTION

The present invention relates to a keyboard combined with a data storage medium, and especially to an independent device combing a keyboard, a data storage medium, and a communication means so that the present invention may communicate with a client system, such as a portable, a handheld or a desktop computer.

### BACKGROUND OF THE INVENTION

The prior art handheld client system, such as a portable computer, a pocket personal computer, is used to take notes and run some simple applications, and is often necessary to transfer data back and forth between it and a PC system. Therefore, the prior art handheld system is usually installed with a connector or an infrared ray transceiver for transferring data. However, for the increasing amount of data and size of applications, and for the limited amount of the memory in a handheld client system, it is beneficial to provide an easy way to expand the storage space of the prior art handheld systems. Furthermore, a commonly used pen input device of a portable computer is not a perfect design, and thus it is necessary to be further improved. Further, the keyboard in the portable computer device is generally connected in a wired way so that some inconvenience is induced.

Therefore, there is an eager demand for a novel keyboard combined with a data storage medium which may improve the prior art disadvantages.

### SUMMARY OF THE INVENTION

Accordingly, the primary object of the present invention is to provide a keyboard combined with a data storage medium. The input data is transferred through wires or through their to a client system, such as a portable, a handheld or a desktop computer. A slot is installed for being inserted by various recording medium for making a standby copy. A transmission means is included for communicating with a client system.

To achieve the object, the present invention provides a keyboard combined with a data storage medium comprising a housing, a keyboard and a storage medium. The housing is installed with a slot and is installed with a transmission portion for being connected to a computer device. The transmission portion is a connecting port capable of being connected to a connector or an optical transmission module. The optical transmission module is an infrared ray transceiver The client system is a computer device or a pocket personal computer. The keyboard is installed on the housing for inputting data and by the transmission portion, and the input data of the keyboard is transferred to the computer device. A storage medium is inserted into the slot for storing data, and by a transmission portion, the storage medium is communicated with the computer device. The storage medium can be a magnetic medium such as a floppy diskette, an optical medium such as an MO, or a semiconductor medium such as a memory chipset, a compact flash card, or a smart card.

The various objects and advantages of the present invention will be more readily understood from the following detailed description when read in conjunction with the appended drawing.

### BRIEF DESCRIPTION OF THE DRAWINGS

Fig, 1 is a perspective view of the present invention,

FIG. 2 shows out embodiment of the present invention connected through wires to a client system.

FIG. 3 shows another embodiment of the present invention connected directly to a handheld client system.

FIG. 4 shows still another embodiment of the present invention communicating with a client device through the air.

FIG. 5 is a perspective view showing that the storage medium in the present invention is a floppy disk.

### DETAILED DESCRIPTION OF THE PREFERRED EMBODIMENTS

To further understand the present invention, a detail description of the present invention will be described in the following with the appended drawings. Those skills in the art may completely understand the objects, characteristics and features of the present invention from these descriptions. However, those descriptions and the appended drawings are only used to describe the present invention instead of being used to confine the spirit and scope of the present invention defined in the appended claims.

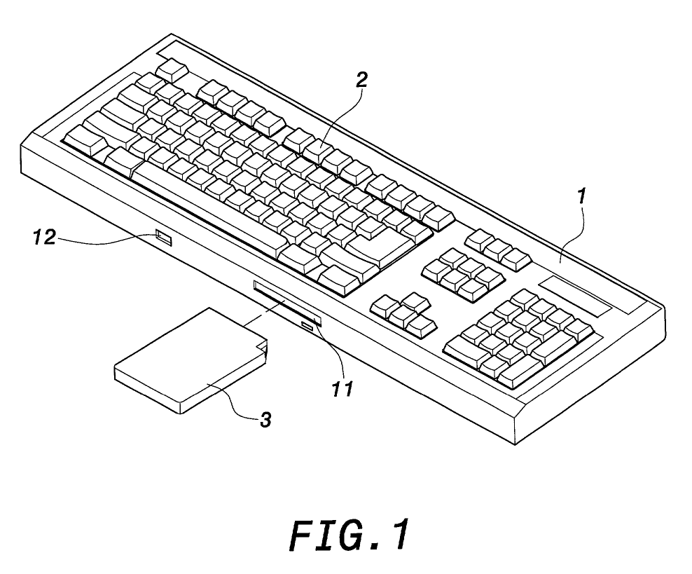

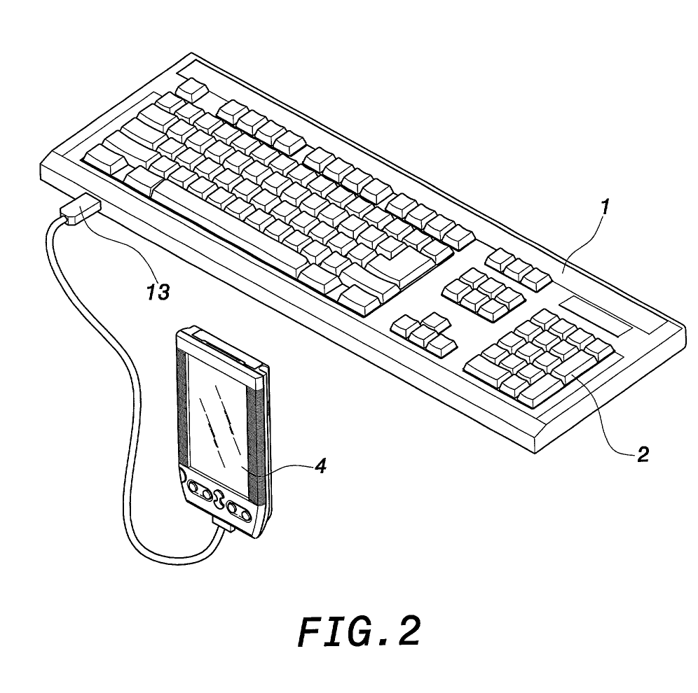

With reference to FIGS. 1 and 2, the keyboard combined with a data storage medium of the present invention is illustrated. The keyboard combined with a data storage medium includes a housing 1, a keyboard 2, and a storage medium 3.

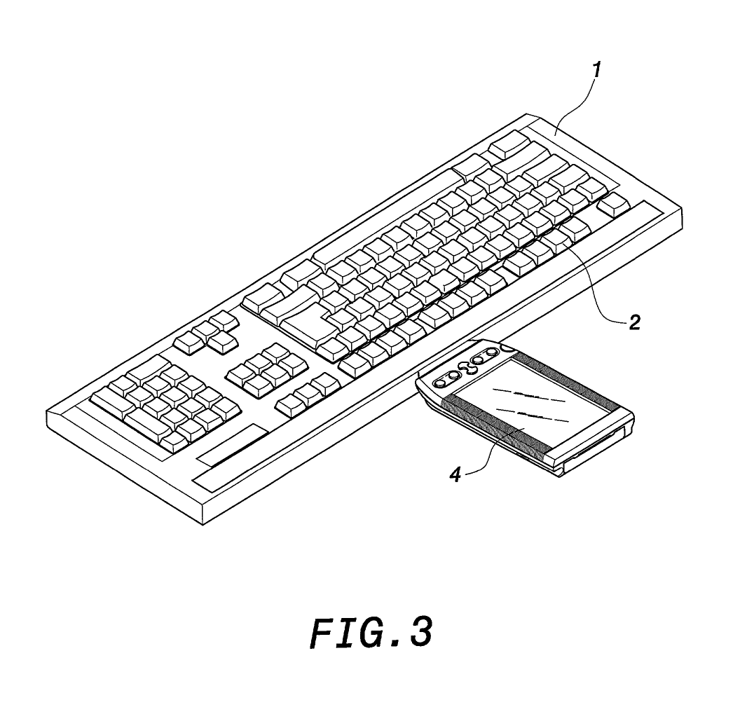

The housing 1 has a slot 11 and is installed with a connecting port 12. The connecting port 12 is a transmission portion which can be inserted with a connector 13 so as to be connected to a computer device, such as a portable, a handheld or a desktop computer, such as a personal digital assistant or a pocket personal computer, and to transmit data in a wired way. The present invention can be powered by batteries installed inside housing 1, by an external power adaptor, or by the client system directly.(refer to FIG. 3.).

The keyboard 2 is installed on the housing 1 and the data thereof is inputted from the user and then through the connector 13 to the computer device.

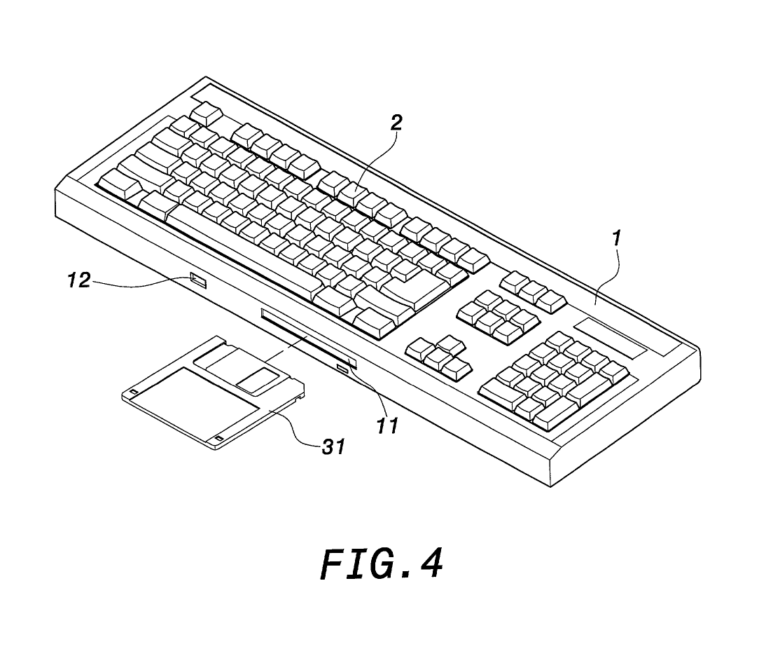

The storage medium 3 may be a semiconductor medium, such as a CF card, an SM card, a memory chip set, etc, or may be a magnetic medium, such as a floppy disk (referring to FIG. 4) for storing data as a standby one. When the storage medium 3 is inserted into the slot 11 of the housing 1, through the connector 13, data or files are transferred between the storage medium 3 and the computer device.

Thereby, by the keyboard 2 of the present invention, the input data can be transferred to the computer device 4 in a wired or wireless way. Furthermore, since the slot 11 is installed, the storage medium 3 can be inserted for make a standby copy of the data. Thereby, data and files can be transferred between the storage medium 3 and the computer device 4.

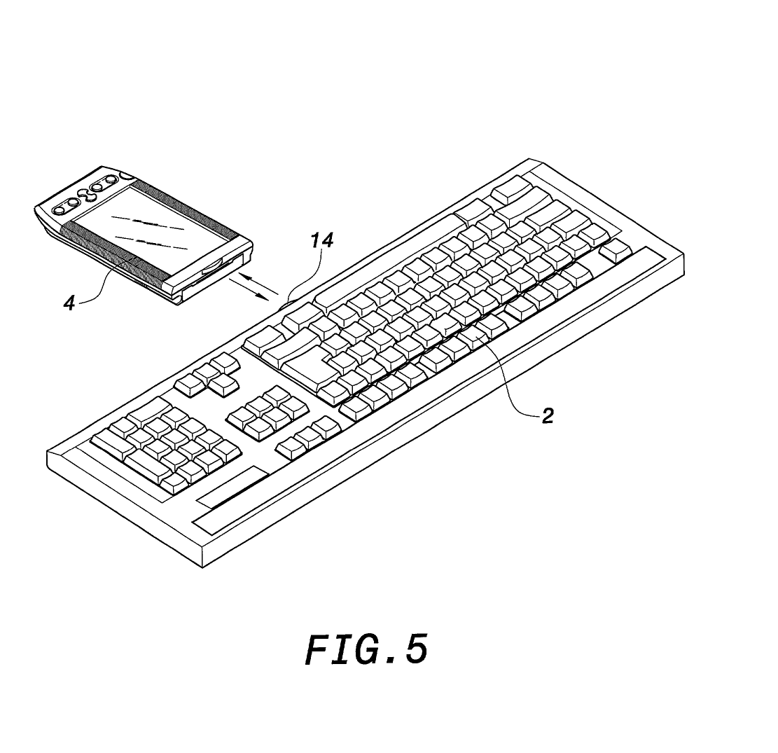

Referring to FIG. 5, another embodiment of the present invention is illustrated. In this embodiment, the housing 1 may be an infrared ray transceiver 14. The infrared ray transceiver 14 is an optical transmission module. When the user inputs data from the keyboard 2, the input data can be transferred to the computer device 4 through the infrared ray transceiver 14 by a wireless way. Moreover, the storage medium 3 may be communicated with the computer device 4 through the infrared ray transceiver 14 in a wireless way.

Therefore, the keyboard combined with a data storage medium of the present invention has the following features.

(1) When the user inputs data from the keyboard, the input data can be transferred to the computer device.

(2) The storage medium can be inserted for make a standby copy of the data. Thereby, data and files can be transferred between the storage medium and the computer device.

(3) A wired or wireless way can be used in the transmission.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A keyboard combined with a data storage medium comprising:
a housing installed with a slot and installed with a transmission means for transferring data to and from a client system;
a keyboard installed on the housing for easier typing, or giving commands to operate the client system, and data or commands are transferred through the transmission means; and
a storage medium inserted into the slot for expanding the storage space of the client system.

2. The keyboard combined with a data storage medium as claimed in claim 1, wherein the keyboard is powered by batteries inside the housing, or is powered by an external adaptor, or by the client system to which the device is connected.

3. The keyboard combined with a data storage medium as claimed in claim 1, wherein the transmission means is a connecting port available for wire connection to a client system.

4. The keyboard combined with a data storage medium as claimed in claim 1, wherein the transmission means is an opticalal transmission module.

5. The keyboard combined with a data storage medium as claimed in claim 4, wherein the optical transmission module is an infrared ray transceiver.

6. The keyboard combined with a data storage medium as claimed in claim 1, wherein the storage medium is a magnetic medium or a semiconductor medium.

7. The keyboard combined with a data storage medium as claimed in claim 6, wherein the magnetic medium is a floppy disk.

8. The keyboard combined with a data storage medium as claimed in claim 6, wherein the semiconductor medium is a memory chipset a compact flash card or a smart card.

9. The keyboard combined with a data storage medium as claimed in claim 1, wherein the client system is selected from one of a group containing a portable computer and a desktop computer.

10. The keyboard combined with a data storage medium as claimed in claim 9, wherein the portable computer device is selectable from one of a group containing a personal digital assistant, a handheld computer and a pocket personal computer.

11. The keyboard combined with a data storage medium as claimed in claim 1, wherein the storage space can store any form of data, or executable applications to increase the versatility of a handheld client system while a PC system is not reachable.
